(19) United States
(12) Patent Application Publication
(10) Pub. No.: US 2024/0139759 A1
(43) Pub. Date: May 2, 2024

(54) VEHICLE SENSOR CLEANING NOZZLE

(71) Applicant: GM Global Technology Operations LLC, Detroit, MI (US)

(72) Inventors: Thomas W. Jozwiak, Southgate, MI (US); Chijou Wang, Farmington Hills, MI (US); Grant W. Brady, Fenton, MI (US)

(21) Appl. No.: 18/312,016

(22) Filed: May 4, 2023

Related U.S. Application Data
(60) Provisional application No. 63/420,800, filed on Oct. 31, 2022.

(51) Int. Cl. B05B 1/04; B05B 15/658; B60S 1/56

(52) U.S. Cl. CPC B05B 1/044; B05B 15/658; B60S 1/56; B60S 1/54

(57) ABSTRACT

A sensor cleaning nozzle includes a nozzle housing including a first end and a second end defining a head portion, and a nozzle system arranged within the nozzle housing. The nozzle system includes a fluid feed member including a fluid feed inlet arranged at the first end and a fluid feed outlet arranged in the head portion. A cleaning nozzle is arranged in the head portion. The cleaning nozzle includes a nozzle inlet is fluidically connected to the fluid feed outlet, a nozzle outlet is exposed at the head portion, and a nozzle bore extends between the nozzle inlet and the nozzle outlet. The nozzle bore converges from the nozzle inlet toward the nozzle outlet along a first nozzle axis and diverges from the nozzle inlet toward the nozzle outlet along a second nozzle axis.

### CROSS-REFERENCE TO RELATED APPLICATIONS

This application claims the benefit of U.S. Provisional Application No. 63/420,800 filed Oct. 31, 2022, the disclosure of which is incorporated herein by reference in its entirety.

### INTRODUCTION

The subject disclosure relates to the art of cleaning systems and, more particularly, to a nozzle for cleaning vehicle sensor surfaces.

Vehicles include a wide array of sensors that detect various environmental elements. Sensors may be used to detect a rapidly approaching vehicle to indicate a need for braking, an oncoming vehicle as a signal to reduce light output, and/or the lack of an oncoming vehicle as a signal to increase light output. Vehicles also include a wide array of cameras that may help with parking, driving in reverse and the like. As vehicles grow in sophistication, and the development of autonomous vehicles advances, the need for more sensors on the vehicle evolves.

During use, sensors may get dirty. Road debris, bugs, dust, rain, and the like may cover a sensor lens. When covered, the senor does not operate at peak performance. Many vehicles include sensor cleaning systems that may direct a fluid, such as a washing liquid and/or air onto the sensor lens to remove dirt. The sensor cleaning systems work best when the vehicle is not traveling. Aero disturbances, in the form of air currents, flowing over the vehicle may impact cleaning quality by moving the fluid away from the sensor lens. Reducing the cleaning quality may reduce an overall efficacy of the sensor. Accordingly, it is desirable to provide system that may effectively clean sensor surfaces when a vehicle is traveling.

### SUMMARY

A sensor cleaning nozzle, in accordance with a non-limiting example, includes a nozzle housing including a first end and a second end defining a head portion, and a nozzle system arranged within the nozzle housing. The nozzle system includes a fluid feed member including a fluid feed inlet arranged at the first end and a fluid feed outlet arranged in the head portion. A cleaning nozzle is arranged in the head portion. The cleaning nozzle includes a nozzle inlet is fluidically connected to the fluid feed outlet, a nozzle outlet is exposed at the head portion, and a nozzle bore extends between the nozzle inlet and the nozzle outlet. The nozzle bore converges from the nozzle inlet toward the nozzle outlet along a first nozzle axis and diverges from the nozzle inlet toward the nozzle outlet along a second nozzle axis.

In addition to one or more of the features described herein the second nozzle axis is substantially perpendicular to the first nozzle axis.

In addition to one or more of the features described herein the nozzle outlet includes a generally rectangular shape having a first dimension that extends along the first nozzle axis and a second dimension that extends along the second nozzle axis, the second dimension being at least three times greater than the first dimension.

In addition to one or more of the features described herein the fluid feed member extends along a third axis, the nozzle outlet extending at a non-zero angle relative to the third axis.

In addition to one or more of the features described herein the nozzle outlet is coaxial with the third axis.

A vehicle in accordance with a non-limiting example, includes a body, a sensor having a sensor surface mounted to the body and a sensor cleaning nozzle mounted to the body and directed at the sensor surface. The sensor cleaning nozzle includes a nozzle housing including a first end and a second end defining a head portion and a nozzle system including a fluid feed member arranged in the nozzle housing. The nozzle system includes a fluid feed inlet arranged at the first end and a fluid feed outlet arranged in the head portion, and a cleaning nozzle arranged in the head portion. The cleaning nozzle including a nozzle inlet fluidically connected to the fluid feed outlet, a nozzle outlet exposed at the head portion and a nozzle bore extending between the nozzle inlet and the nozzle outlet. The nozzle bore converges from the nozzle inlet toward the nozzle outlet along a first nozzle axis and diverges from the nozzle inlet toward the nozzle outlet along a second nozzle axis.

In addition to one or more of the features described herein the second nozzle axis is substantially perpendicular to the first nozzle axis.

In addition to one or more of the features described herein the nozzle outlet includes a generally rectangular shape having a first dimension that extends along the first nozzle axis and a second dimension that extends along the second nozzle axis, the second dimension being at least three times greater than the first dimension.

In addition to one or more of the features described herein the fluid feed member extends along a third axis, the nozzle outlet extending at a non-zero angle relative to the third axis.

In addition to one or more of the features described herein the nozzle outlet is coaxial with the third axis.

A method of cleaning a sensor surface on a vehicle traveling at road speeds includes passing a fluid through a fluid feed member to a nozzle inlet of a sensor cleaning nozzle, converging the fluid along a first nozzle axis through a nozzle bore, and diverging the fluid along a second nozzle axis through the nozzle bore, and passing the fluid from a nozzle outlet having a generally rectangular shape toward the sensor surface.

In addition to one or more of the features described herein passing the fluid from the nozzle outlet includes imparting a blade-shaped profile to the fluid.

In addition to one or more of the features described herein imparting the blade-shaped profile includes creating a fluid profile having a profile width that is at least three times wider than a profile thickness.

In addition to one or more of the features described herein passing the fluid through the fluid feed member includes directing a compressible fluid into the sensor cleaning nozzle.

In addition to one or more of the features described herein converging the compressible fluid along the first nozzle axis through the nozzle bore, and diverging the compressible fluid along the second nozzle axis through the nozzle bore generates a high velocity shaped exit stream.

In addition to one or more of the features described herein passing the fluid from the nozzle outlet includes imparting a cleaning affect to at least 70% of the sensor surface as the vehicle travels at road speed.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a sensor cleaning nozzle, in accordance with a non-limiting example;

FIG. 2 is a view of a nozzle housing including the sensor cleaning nozzle, in accordance with a non-limiting example;

FIG. 3 is a view of a head portion of the nozzle housing showing a nozzle outlet, in accordance with a non-limiting example;

FIG. 4 is a view of the sensor cleaning nozzle, in accordance with a non-limiting example;

FIG. 5 is a top view of the sensor cleaning nozzle of FIG. 4, in accordance with a non-limiting example;

FIG. 6 is a view of a sensor cleaning nozzle, in accordance with a non-limiting example;

FIG. 7 is a top view of the sensor cleaning nozzle of FIG. 6, in accordance with a non-limiting example; and

FIG. 8 is a flow chart depicting a method of cleaning a sensor surface with the sensor cleaning nozzle, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

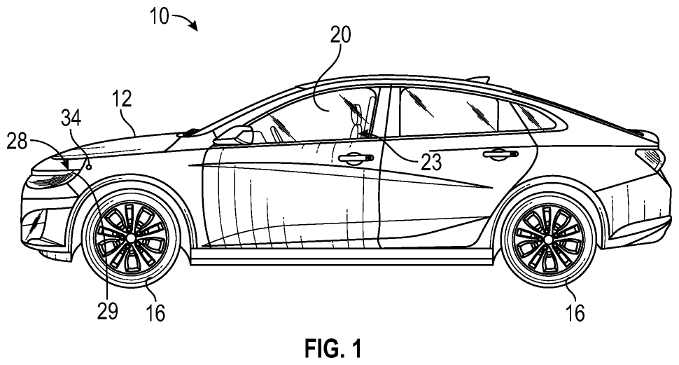

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats, one of which is indicated at 23, positioned behind a dashboard 26. Body 12 also supports a number of sensors or cameras, such as indicated at 28, including a sensor surface 29.

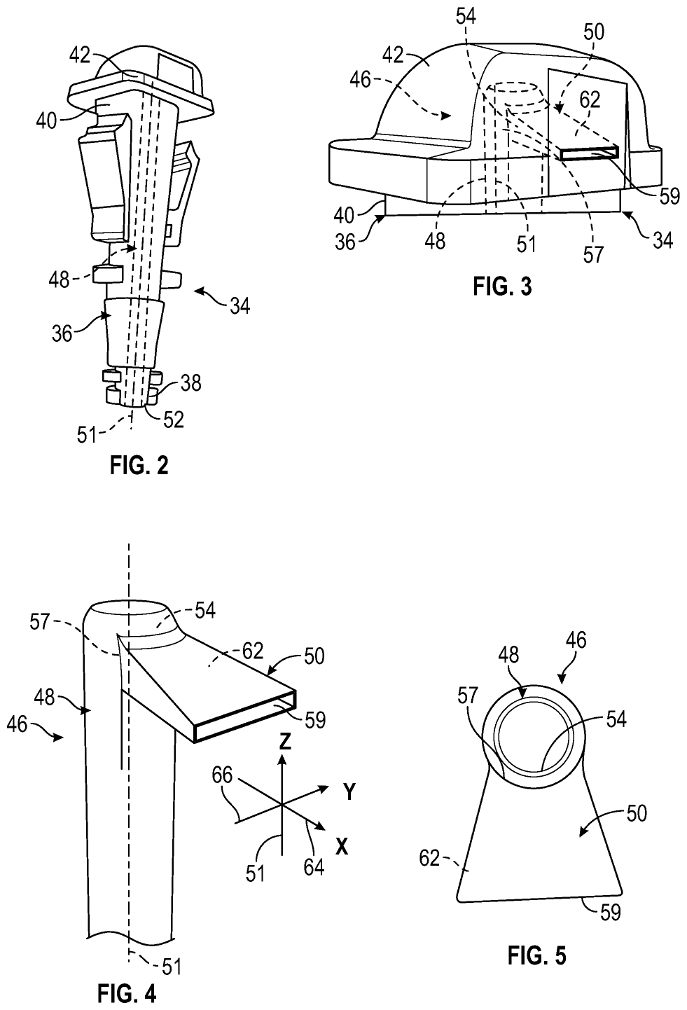

In a non-limiting example, a sensor cleaning nozzle 34 is mounted to body 12. Referring to FIG. 2 and FIG. 3, sensor cleaning nozzle 34 includes a nozzle housing 36 including a first end 38 and a second end 40. A head portion 42 is arranged at second end 40. A nozzle system 46 is arranged within nozzle housing 36. Nozzle system 46 includes a fluid feed member 48 that delivers fluid to a cleaning nozzle 50 (FIG. 4). Fluid feed member 48 extends along a fluid delivery axis 51 and includes a fluid feed inlet 52 arranged at first end 38 of nozzle housing 36 and fluid feed outlet 54 arranged at head portion 42. Fluid feed inlet 52 receives a cleaning fluid, which in a non-limiting example, is a compressible fluid such as air. The compressible fluid is passed into cleaning nozzle 50 and accelerated onto sensor surface 29.

In a non-limiting example, shown in FIG. 3, FIG. 4, and FIG. 5, cleaning nozzle 50 includes a nozzle inlet 57, a nozzle outlet 59, and a nozzle bore 62. Nozzle bore 62 converges from nozzle inlet 57 toward nozzle outlet 59 along a first nozzle axis 64 (FIG. 4). Nozzle bore 62 also diverges from nozzle inlet 57 toward nozzle outlet 59 along a second nozzle axis 66. First nozzle axis 64 is substantially perpendicular to second nozzle axis 66. First nozzle axis 64 and second nozzle axis 66 are substantially perpendicular to fluid delivery axis 51. With this arrangement, nozzle outlet 59 extends at a non-zero angle relative to fluid feed member 48. In a non-limiting example, nozzle outlet 59 includes a generally rectangular shape having a first dimension that extends along first nozzle axis 64 and a second dimension that extends along second nozzle axis 66. The second dimension is at least three times greater than the first dimension.

The particular geometry cleaning of nozzle 50 creates and delivers a high velocity stream of the cleaning fluid toward sensor surface. In a monitoring example, the stream of cleaning fluid has a thin and wide dispersion pattern for the purpose of creating maximum effective surface shear (skin friction coefficient) over a large dispersion pattern (% target area), with minimum required mass flow. This results in maximum surface clearing/cleaning performance with minimized angular targeting sensitivity to environmental wind and vehicle velocity aero disturbances, accomplished with minimum system input energy.

Internal geometry of cleaning nozzle 50 converts cylindrical supply line cleaning fluid delivery into precisely shaped outlet flow. Progressive cross sectional area scheduling is used to produce a minimized vertical (perpendicular to mounting surface) cleaning fluid flow thickness via converging wall surfaces, while delivering required radial angles via diverging wall angles. Cleaning fluid stream vertical delivery angle relative to target surface plane, in combination with distance and geometric area size to be cleaned/cleared, is matched to internal nozzle dimensions.

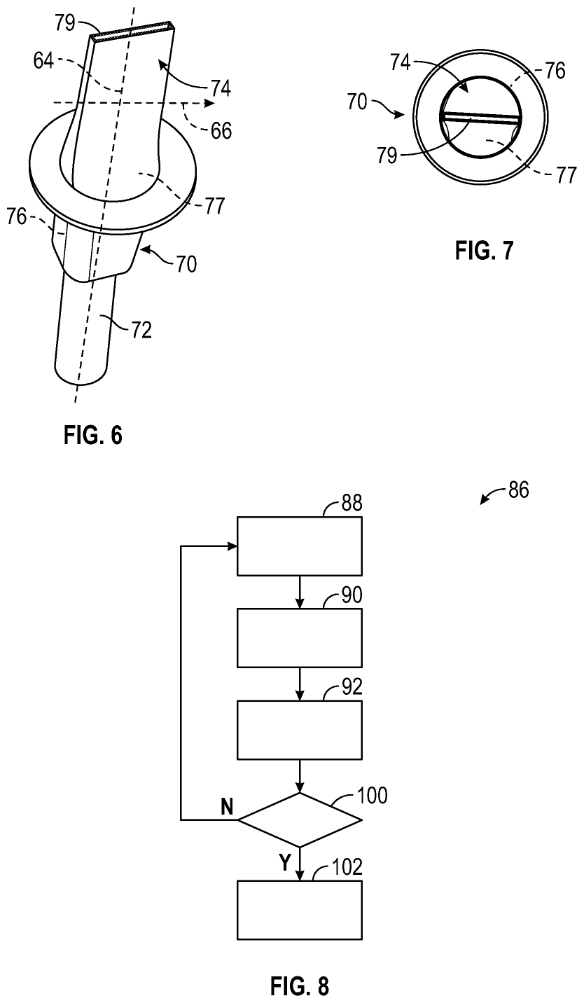

A sensor cleaning nozzle 70 in accordance with another non-limiting example, is shown in FIG. 6 and FIG. 7. Sensor cleaning nozzle 70 includes a fluid feed member 72 (FIG. 6) that delivers a cleaning fluid to a cleaning nozzle 74. Cleaning nozzle 74 includes a nozzle inlet 76, a nozzle bore 77, and a nozzle outlet 79. In a non-liming example, fluid feed member 72 and nozzle outlet 79 are coaxial. Nozzle bore 77 converges from nozzle inlet 76 toward nozzle outlet 79 along the first nozzle axis 64. Nozzle bore 77 also diverges from nozzle inlet 76 toward nozzle outlet 79 along the second nozzle axis 66. In a manner similar to that described herein, the geometry of cleaning nozzle 70 delivers a high velocity cleaning fluid stream in a thin wide dispersion pattern for the purpose of creating maximum effective surface shear (skin friction coefficient) over a large dispersion pattern (% target area), with minimum required mass flow.

Reference will now follow to FIG. 8 in describing a method 86 of cleaning sensor surface 29 using sensor cleaning nozzle 34 while vehicle 10 is traveling at road speeds. In block 88, a cleaning fluid is passed through fluid feed member 48 to nozzle inlet 57. The cleaning fluid converges along first nozzle axis 64 through nozzle bore 62 and diverges along second nozzle axis 66 through nozzle bore 62 in block 90. The cleaning fluid is then passed from nozzle outlet 59 onto sensor surface 29 in block 92. The cleaning fluid may possess a blade shaped profile when leaving nozzle outlet 59. In block 100, a determination is made whether sensor surface 29 is clean. If not, the method returns to block 88. If sensor surface 29 is clean, fluid delivery ends in block 102. In a non-limiting example, sensor cleaning nozzle 34 is configured to impart a cleaning affect to at least 70% of sensor surface 29 as the vehicle travels at road speed.

At this point it should be understood that while described in terms of sensor cleaning nozzle 34, method 86 can also be carried out by sensor cleaning nozzle 70. Further, while described as employing a compressible fluid, sensor cleaning nozzle may, in the alternative employ a non-compressible fluid and/or operate in combination with another nozzle the delivers non-compressible fluid into a sensor surface. In such a case, the sensor cleaning nozzle disclosed in accordance with the non-limiting examples described herein will not only remove dirt from the sensor surface but also create a drying affect that removes the non-compressible fluid.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A sensor cleaning nozzle comprising:
a nozzle housing including a first end and a second end defining a head portion; and
a nozzle system arranged within the nozzle housing, the nozzle system including a fluid feed member including a fluid feed inlet arranged at the first end and a fluid feed outlet arranged in the head portion, and a cleaning nozzle arranged in the head portion, the cleaning nozzle including a nozzle inlet fluidically connected to the fluid feed outlet, a nozzle outlet exposed at the head portion and a nozzle bore extending between the nozzle inlet and the nozzle outlet, the nozzle bore converging from the nozzle inlet toward the nozzle outlet along a first nozzle axis and diverging from the nozzle inlet toward the nozzle outlet along a second nozzle axis.

2. The sensor cleaning nozzle according to claim 1, wherein the second nozzle axis is substantially perpendicular to the first nozzle axis.

3. The sensor cleaning nozzle according to claim 1, wherein the nozzle outlet includes a generally rectangular shape having a first dimension that extends along the first nozzle axis and a second dimension that extends along the second nozzle axis, the second dimension being at least three times greater than the first dimension.

4. The sensor cleaning nozzle according to claim 1, wherein the fluid feed member extends along a third axis, the nozzle outlet extending at a non-zero angle relative to the third axis.

5. The sensor cleaning nozzle according to claim 4, wherein the nozzle outlet is coaxial with the third axis.

6. A vehicle comprising:
a body;
a sensor mounted to the body, the sensor having a sensor surface; and
a sensor cleaning nozzle mounted to the body and directed at the sensor surface, the sensor cleaning nozzle comprising:
a nozzle housing including a first end and a second end defining a head portion; and
a nozzle system including a fluid feed member including a fluid feed inlet arranged at the first end and a fluid feed outlet arranged in the head portion, and a cleaning nozzle arranged in the head portion, the cleaning nozzle including a nozzle inlet fluidic ally connected to the fluid feed outlet, a nozzle outlet exposed at the head portion and a nozzle bore extending between the nozzle inlet and the nozzle outlet, the nozzle bore converging from the nozzle inlet toward the nozzle outlet along a first nozzle axis and diverging from the nozzle inlet toward the nozzle outlet along a second nozzle axis.

7. The vehicle according to claim 6, wherein the second nozzle axis is substantially perpendicular to the first nozzle axis.

8. The vehicle according to claim 6, wherein the nozzle outlet includes a generally rectangular shape having a first dimension that extends along the first nozzle axis and a second dimension that extends along the second nozzle axis, the second dimension being at least three times greater than the first dimension.

9. The vehicle according to claim 6, wherein the fluid feed member extends along a third axis, the nozzle outlet extending at a non-zero angle relative to the third axis.

10. The vehicle according to claim 9, wherein the nozzle outlet is coaxial with the third axis.

11. A method of cleaning a sensor surface on a vehicle traveling at road speed comprising:
passing a fluid through a fluid feed member to a nozzle inlet of a sensor cleaning nozzle;
converging the fluid along a first nozzle axis through a nozzle bore, and diverging the fluid along a second nozzle axis through the nozzle bore; and
passing the fluid from a nozzle outlet having a generally rectangular shape toward the sensor surface.

12. The method of claim 11, wherein passing the fluid from the nozzle outlet includes imparting a blade-shaped profile to the fluid.

13. The method of claim 12, wherein imparting the blade-shaped profile includes creating a fluid profile having a profile width that is at least three times wider than a profile thickness.

14. The method of claim 11, wherein passing the fluid through the fluid feed member includes directing a compressible fluid into the sensor cleaning nozzle.

15. The method of claim 14, wherein converging the compressible fluid along the first nozzle axis through the nozzle bore, and diverging the compressible fluid along the second nozzle axis through the nozzle bore generates a high velocity shaped exit stream.

16. The method of claim 11, wherein passing the fluid from the nozzle outlet includes imparting a cleaning affect to at least 70% of the sensor surface as the vehicle travels at road speed.
